(19) United States
(12) Patent Application Publication
(10) Pub. No.: US 2012/0300518 A1
(43) Pub. Date: Nov. 29, 2012

(54) TWO-TERMINAL CURRENT CONTROLLER AND RELATED LED LIGHTING DEVICE

(76) Inventors: Yung-Hsin Chiang, New Taipei City (TW); Yi-Mei Li, New Taipei City (TW); Alberto Giovanni Viviani, Mountain View, CA (US)

(21) Appl. No.: 13/570,212

(22) Filed: Aug. 8, 2012

Related U.S. Application Data
(63) Continuation-in-part of application No. 12/796,674, filed on Jun. 9, 2010, now Pat. No. 8,288,960.

(30) Foreign Application Priority Data
Apr. 15, 2010 (TW) 099111804

(51) Int. Cl. H02M 7/06

(52) U.S. Cl. 363/126

(57) ABSTRACT

A two-terminal current controller controls a first current flowing through a parallel-coupled load. During a rising period of a rectified AC voltage, when a load voltage does not exceed a first voltage, the two-terminal current controller operates in a first mode. When the load voltage exceeds the first voltage but does not exceed a second voltage, the two-terminal current controller operates in a second mode. When the load voltage exceeds the second voltage, the two-terminal current controller operates in a third mode. When the load voltage drops to a third voltage smaller than the second voltage after exceeding the second voltage, the two-terminal current controller operates in the second mode when a difference between the second and third voltages exceeds a hysteresis band and operates in the third mode when a difference between the second and third voltages does not exceed the hysteresis band.

### CROSS REFERENCE TO RELATED APPLICATIONS

This is a continuation-in-part of U.S. application Ser. No. 12/796,674, which was filed on 9 Jun. 2010 and is included herein by reference.

### BACKGROUND OF THE INVENTION

1. Field of the Invention

The present invention is related to a two-terminal current controller, and more particularly, to a two-terminal current controller with high power factor, high noise resistance and short turn-on time.

2. Description of the Prior Art

Compared to traditional incandescent bulbs, light-emitting diodes (LEDs) are advantageous in low power consumption, long lifetime, small size, no warm-up time, fast reaction speed, and the ability to be manufactured as small or array devices. In addition to outdoor displays, traffic signs, and LCD backlight for various electronic devices such as mobile phones, notebook computers or personal digital assistants (PDAs), LEDs are also widely used as indoor/outdoor lighting devices in place of fluorescent of incandescent lamps.

FIG. 1 is a diagram illustrating the voltage-current chart of a light-emitting diode. When the forward-bias voltage of the light-emitting diode is smaller than its barrier voltage Vb, the light-emitting diode functions as an open-circuited device since it only conducts a negligible amount of current. When the forward-bias voltage of the light-emitting diode exceeds its barrier voltage Vb, the light-emitting diode functions as a short-circuited device since its current increases exponentially with the forward-bias voltage. The barrier voltage Vb, whose value is related to the material and doping type of the light-emitting diode, is typically between 1.5 and 3 volts. For most current values, the luminescence of the light-emitting diode is proportional to the current. Therefore, a current source is generally used for driving light-emitting diodes in order to provide uniform luminescence.

FIG. 2 is a diagram of a prior art LED lighting device 500. The LED lighting device 500 includes a power supply circuit 110, a resistor R and a luminescent device 10. The power supply circuit 110 is configured to receive an alternative-current (AC) voltage VS having positive and negative periods and convert the output of the AC voltage VS in the negative period using a bridge rectifier 112, thereby providing a rectified AC voltage V_{AC}, whose value varies periodically with time, for driving the luminescent device 10. The resistor R is coupled in series with the luminescent device 10 for regulating its current I_{LED}. In many applications, multiple light-emitting diodes are required in order to provide sufficient brightness. Since a light-emitting diode is a current-driven device whose luminescence is proportional to its driving current, the luminescent device 10 normally adopts a plurality of light-emitting diodes D₁-Dₙ coupled in series. Assuming that the barrier voltage of all the light-emitting diodes D₁-Dₙ is equal to the ideal value Vb and the rectified AC voltage V_{AC} varies between 0 and V_{MAX} with time, a forward-bias voltage larger than n*Vb is required for turning on the luminescent device 10. Therefore, the energy between 0 and n*Vb cannot be used. As the number of the light-emitting diodes D₁-Dₙ increases, a higher forward-bias voltage is required for turning on the luminescent device 10, thereby reducing the effective operational voltage range of the LED lighting device 500; as the number of the light-emitting diodes D₁-Dₙ decreases, the large driving current when V_{AC}=V_{MAX} may impact the reliability of the light-emitting diodes. Therefore, the prior art LED lighting device 500 needs to make compromise between the effective operational voltage range and the reliability. Meanwhile, the current-limiting resistor R also consumes extra power and may thus lower system efficiency.

FIG. 3 is a diagram of another prior art LED lighting device 600. The LED lighting device 600 includes a power supply circuit 110, an inductor L, a capacitor C, a switch SW, and a luminescent device 10. The power supply circuit 110 is configured to receive an AC voltage VS having positive and negative periods and convert the output of the AC voltage VS in the negative period using a bridge rectifier 112, thereby providing a rectified AC voltage V_{AC}, whose value varies periodically with time, for driving the luminescent device 10. The inductor L and the switch SW are coupled in series with the luminescent device 10 for limiting its current I_{LED}. The capacitor C is coupled in parallel with the luminescent device 10 for absorbing voltage ripples of the power supply circuit 110. For the same current-regulating function, the inductor L consumes less energy than the resistor R of the LED lighting device 500. However, the inductor L for regulating current and the capacitor for stabilizing voltage largely reduce the power factor of the LED lighting device 600 and the energy utilization ratio. Therefore, the prior art LED lighting device 600 needs to make compromise between the effective operational voltage range and the brightness.

### SUMMARY OF THE INVENTION

The present invention provides a two-terminal current controller for controlling a first current flowing through a load which is coupled in parallel with the two-terminal current controller. During a rising period of a rectified AC voltage when a voltage established across the load does not exceed a first voltage, the two-terminal current controller operates in a first mode. During the rising period when the voltage established across the load exceeds the first voltage but does not exceed a second voltage, the two-terminal current controller operates in a second mode. During the rising period when the voltage established across the load exceeds the second voltage, the two-terminal current controller operates in a third mode. During the rising period when the voltage established across the load drops to a third voltage smaller than the second voltage after exceeding the second voltage, the two-terminal current controller is configured to operate in the second mode when a difference between the second and third voltages exceeds a first hysteresis band and operate in the third mode when a difference between the second and third voltages does not exceed the first hysteresis band. The two-terminal current controller includes a current limiting unit configured to conduct a second current associated with the rectified AC voltage, regulate the second current according to the voltage established across the load and maintain the first current at zero when the two-terminal current controller operates in the first mode; conduct the second current, maintain the second current at a predetermined value larger than zero and maintain the first current at zero when the two-terminal current controller operates in the second mode; and switch off when the two-terminal current controller operates in the third mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the voltage-current chart of a light-emitting diode.

FIG. 2 is a diagram of a prior art LED lighting device.

FIG. 3 is a diagram of another prior art LED lighting device.

FIGS. 4, 7, 11 and 13 are diagram of LED lighting devices according to embodiments of the present invention.

FIGS. 5 and 9 are diagrams illustrating the current-voltage chart of a two-terminal current controller according to the present invention.

FIGS. 6, 10 and 12 are diagrams illustrating the variations in the related current and voltage when operating the LED lighting device of the present invention.

FIG. 8 is a diagram of an illustrated embodiment of the two-terminal current controller.

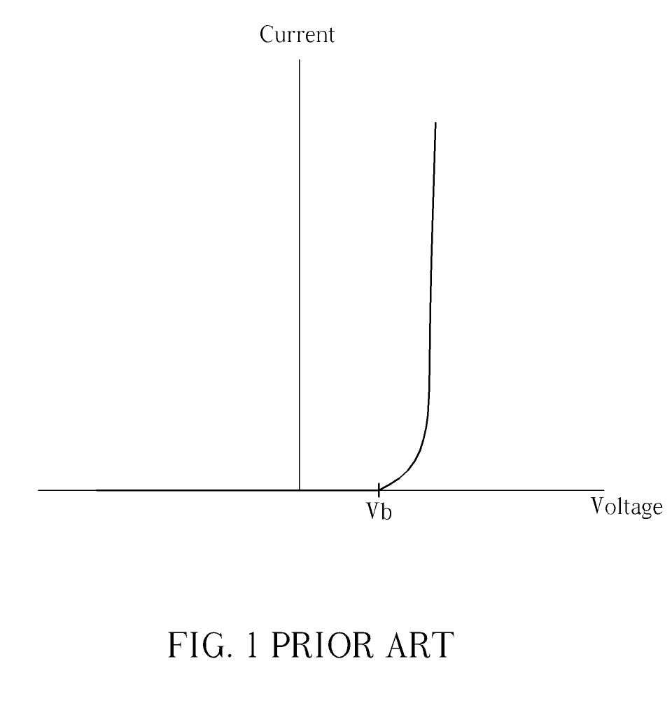

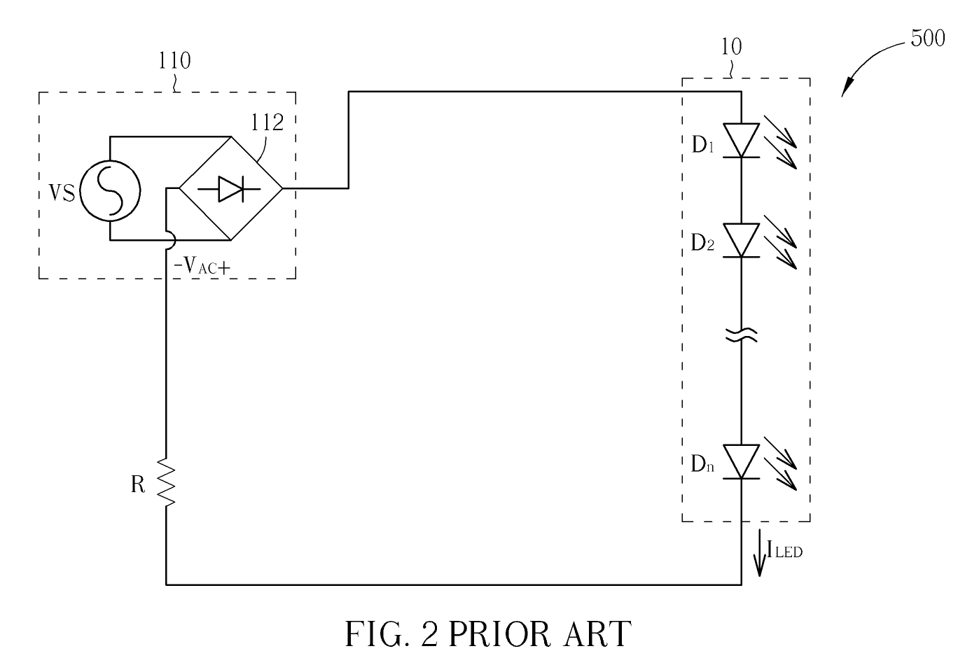

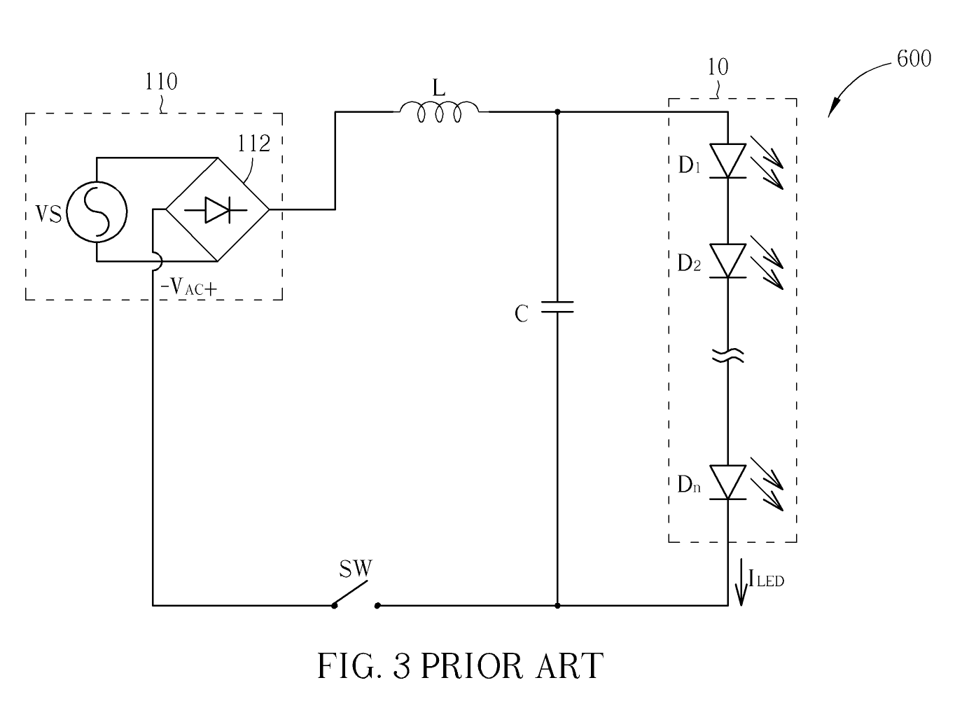

### DETAILED DESCRIPTION

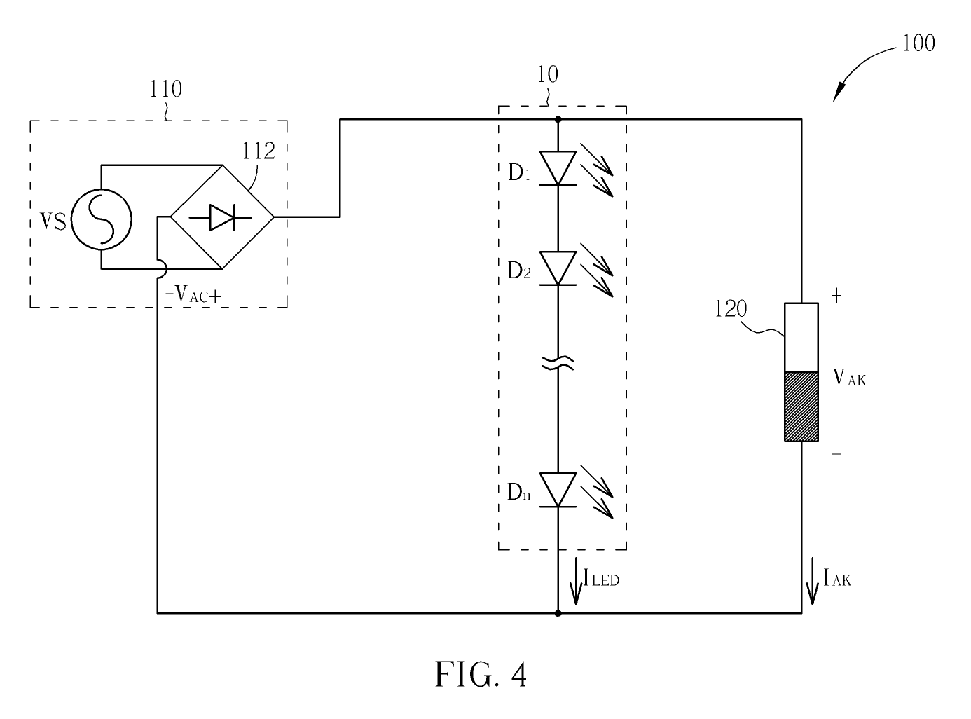

FIG. 4 is a diagram of an LED lighting device 100 according to a first embodiment of the present invention. The LED lighting device 100 includes a power supply circuit 110, a two-terminal current controller 120, and a luminescent device 10. The power supply circuit 110 is configured to receive an AC voltage VS having positive and negative periods and convert the output of the AC voltage VS in the negative period using a bridge rectifier 112, thereby providing a rectified AC voltage V_{AC}, whose value varies periodically with time, for driving the luminescent device 10. The luminescent device 10 may adopt n light-emitting units D₁-Dₙcoupled in series, each of which may include a single light-emitting diode or multiple light-emitting diodes. FIG. 4 depicts the embodiment using a single light-emitting diode, but does not limit the scope of the present invention. I_{LED} represents the current passing through the luminescent device 10 and V_{AK} represents the voltage established across the luminescent device 10. The two-terminal current controller 120, coupled in parallel with the luminescent device 10 and the power supply circuit 110, is configured to control the current I_{LED} passing through the luminescent device 10 according to the rectified AC voltage V_{AC}, wherein I_{AK} represents the current passing through the two-terminal current controller 120. In the first embodiment of the present invention, the barrier voltage Vb′ of the two-terminal current controller 120 is smaller than the overall barrier voltage n*Vb of the luminescent device 10 (assuming the barrier voltage of each light-emitting unit is equal to Vb).

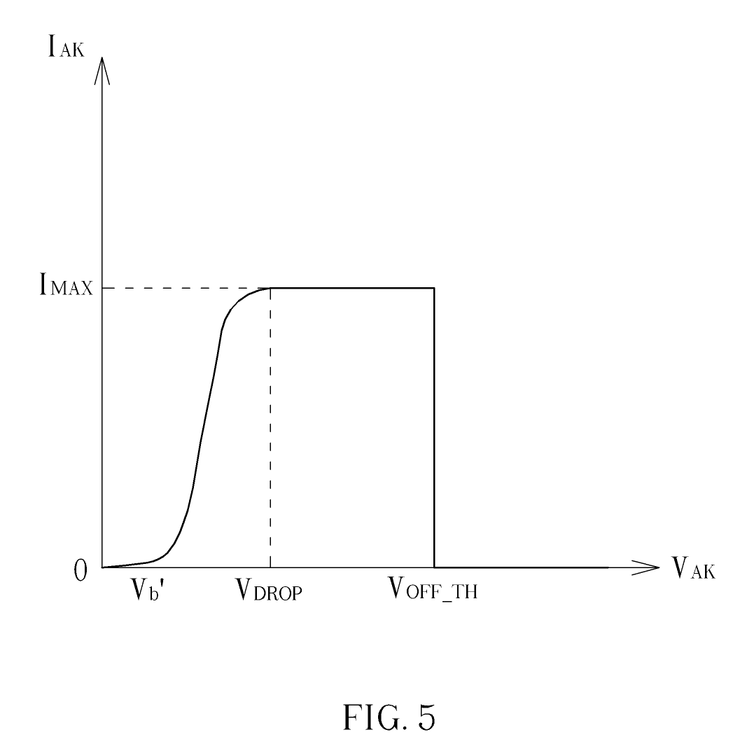

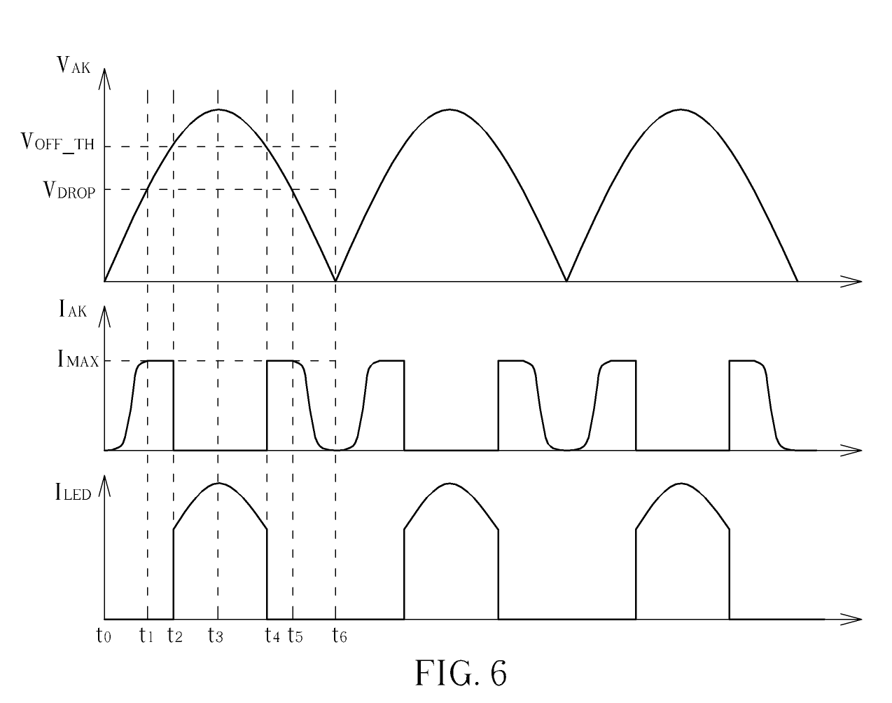

FIGS. 5 and 6 illustrate the operation of the LED lighting device 100, wherein FIG. 5 is a diagram illustrating the current-voltage chart of the two-terminal current controller 120, and FIG. 6 is a diagram illustrating the variations in the related current and voltage when operating the LED lighting device 100. In FIG. 5, the vertical axis represents the current I_{AK} passing through the two-terminal current controller 120, and the horizontal axis represents the voltage V_{AK} established across the two-terminal current controller 120. In the first embodiment of the present invention, the two-terminal current controller 120 operates in a first mode and functions as a voltage-controlled device when 0<V_{AK}<V_{DROP}. In other words, when the voltage V_{AK} exceeds the barrier voltage Vb′ of the two-terminal current controller 120, the current I_{AK} changes with the voltage V_{AK} in a specific manner; the two-terminal current controller 120 operates in a second mode and functions as a constant current source when V_{DROP}<V_{AK}<V_{OFF}_{_{—}}_{TH}. In other words, the current I_{AK} is maintained at a maximum current I_{MAX} instead of changing with the voltage V_{AK}; the two-terminal current controller 120 functions in a third mode and is turned off when V_{AK}>V_{OFF}_{_{—}}_{TH}. In other words, the two-terminal current controller 120 functions as an open-circuited device since the current I_{AK} is suddenly reduced to zero.

FIG. 6 illustrates the waveforms of the voltage V_{AK}, the current I_{AK} and the current I_{LED}. Since the voltage V_{AK} is associated with the rectified AC voltage V_{AC} whose value varies periodically with time, a cycle between t₀-t₆ is used for illustration, wherein the period between t₀-t₃ is the rising period of the rectified AC voltage V_{AC} and the period between t₄-t₆ is the falling period of the rectified AC voltage V_{AC}. Between t₀-t₁ when the voltage V_{AK} gradually increases, the two-terminal current controller 120 is first turned on, after which the current I_{AK} increases with the voltage V_{AK} in a specific manner and the current I_{LED} is maintained at substantially zero. Between t₁-t₂ when the voltage V_{AK} is larger than the voltage V_{DROP}, the two-terminal current controller 120 is configured to limit the current I_{AK} to the maximum current I_{MAX}, and the current I_{LED} remains substantially zero since the luminescent device 10 is still turned off. Between t₂-t₄ when the voltage V_{AK} is larger than the voltage V_{OFF}_{_{—}}_{TH}, the two-terminal current controller 120 is turned off and the current associated with the rectified AC voltage V_{AC} thus flows through the luminescent device 10. Therefore, the current I_{AK} is reduced to zero, and the current I_{LED} changes with the voltage V_{AK}. Between t₄-t₅ when the voltage V_{AK} drops to a value between the voltage V_{DROP} and the voltage V_{OFF}_{_{—}}_{TH}, the two-terminal current controller 120 is turned on, thereby limiting the current I_{AK} to the maximum current I_{MAX} and maintaining the current I_{LED} at substantially zero. Between t₅-t₆ when the voltage V_{AK} drops below the voltage V_{DROP}, the current I_{AK} decreases with the voltage V_{AK} in a specific manner.

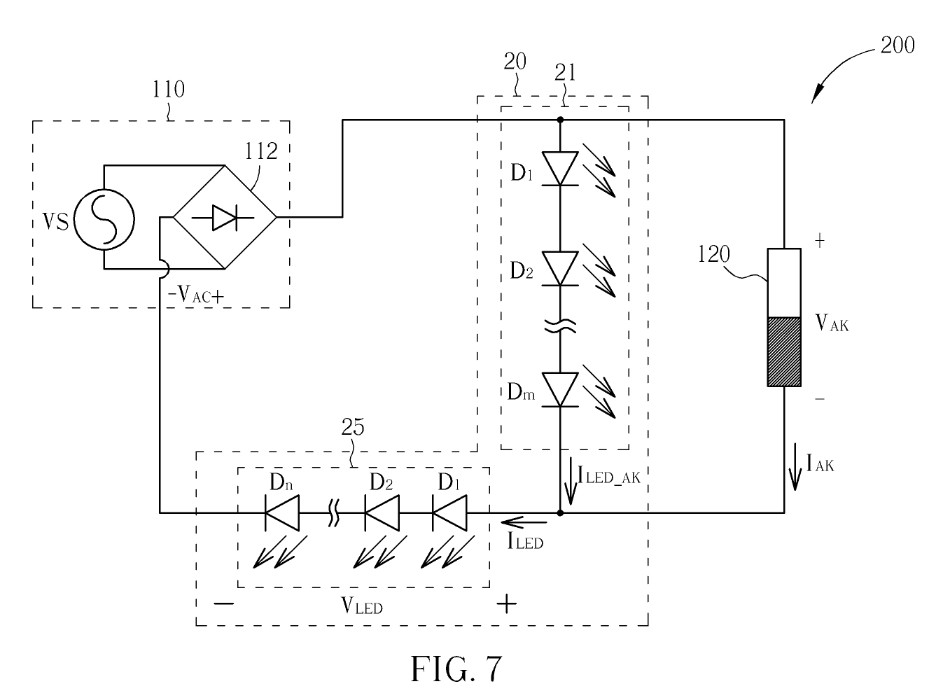

FIG. 7 is a diagram of an LED lighting device 200 according to a second embodiment of the present invention. The LED lighting device 200 includes a power supply circuit 110, a two-terminal current controller 120, and a luminescent device 20. Having similar structures, the first and second embodiments of the present invention differ in the luminescent device 20 and how it is connected to the two-terminal current controller 120. In the second embodiment of the present invention, the luminescent device 20 includes two luminescent elements 21 and 25: the luminescent element 21 is coupled in parallel to the two-terminal current controller 120 and includes m light-emitting units D₁-Dₘ coupled in series, wherein I_{LED}_{_{—}}_{AK} represents the current flowing through the luminescent element 21 and V_{AK} represents the voltage established across the luminescent element 21; the luminescent element 25 is coupled in series to the two-terminal current controller 120 and includes n light-emitting units D₁-Dₙ coupled in series, wherein I_{LED}_{_{—}}_{AK} represents the current flowing through the luminescent element 25 and V_{LED} represents the voltage established across the luminescent element 25. Each light-emitting unit may include a single light-emitting diode or multiple light-emitting diodes. FIG. 7 depicts the embodiment using a single light-emitting diode, but does not limit the scope of the present invention.

The two-terminal current controller 120 is configured to control the current passing through the luminescent device 20 according to the rectified AC voltage V_{AC}, wherein I_{AK} represents the current passing through the two-terminal current controller 120 and V_{AK} represents the voltage established across the two-terminal current controller 120. In the second embodiment of the present invention, the barrier voltage Vb′ of the two-terminal current controller 120 is smaller than the overall barrier voltage m*Vb of the luminescent element 21 (assuming the barrier voltage of each luminescent element is equal to Vb).

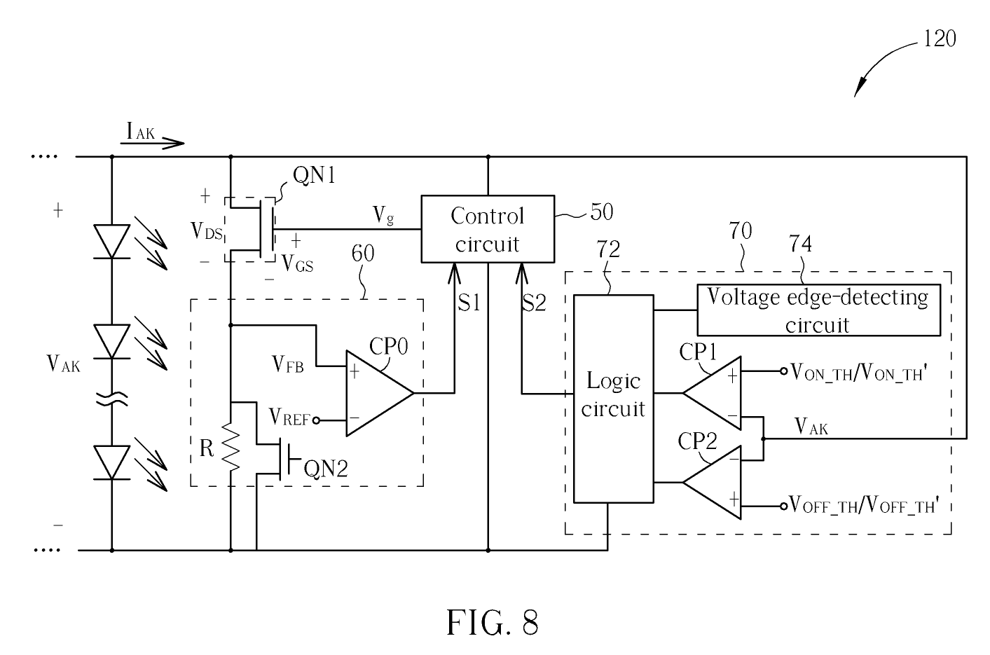

FIG. 8 is a diagram of an illustrated embodiment of the two-terminal current controller 120 in the LED lighting device 200. In this embodiment, the two-terminal current controller 120 includes a switch QN1, a control circuit 50, a current-detecting circuit 60, and a voltage-detecting circuit 70. The switch QN1 may include a field effect transistor (FET), a bipolar junction transistor (BJT) or other devices having similar function. In FIG. 8, an N-type metal-oxide-semiconductor (NMOS) transistor is used for illustration, but does not limit the scope of the present invention. With the gate coupled to the control circuit 50 for receiving a turn-on voltage V_{g}, the drain-to-source voltage, the gate-to-source voltage and the threshold voltage of the switch QN1 are represented by V_{DS}, V_{GS} and V_{TH}, respectively. When the switch QN1 operates in the linear region, its drain current is mainly determined by the drain-to-source voltage V_{DS}; when the switch QN1 operates in the saturation region, its drain current is only related to the gate-to-source voltage V_{GS}.

During the rising period of the rectified AC voltage V_{AC}, the drain-to-source voltage V_{DS} of the switch QN1 increases with the voltage V_{AK}. When the voltage V_{AK} does not exceed V_{DROP}, the drain-to-source voltage V_{DS} is smaller than the difference between the gate-to-source voltage V_{GS} and the threshold voltage V_{TH} (V_{DS}<V_{GS}−V_{TH}). The turn-on voltage V_{g} from the control circuit 50 provides a bias condition V_{GS}>V_{TH} which allows the switch QN1 to operate in the linear region where the drain current is mainly determined by the drain-to-source voltage V_{DS}. In other words, the two-terminal current controller 120 is configured to provide the current I_{AK} and voltage V_{AK} whose relationship corresponds to the I-V characteristic of the switch QN1 when operating in the linear region.

During the rising period of the rectified AC voltage V_{AC} when the voltage V_{AK} falls between V_{DROP} and V_{OFF}_{_{—}}_{TH}, the drain-to-source voltage V_{DS} is larger than the difference between the gate-to-source voltage V_{GS} and the threshold voltage V_{TH} (V_{DS}>V_{GS}−V_{TH}). The turn-on voltage V_{g} from the control circuit 50 provides a bias condition V_{GS}>V_{TH} which allows the switch QN1 to operate in the saturation region where the drain current is only related to the gate-to-source voltage V_{GS} and the current I_{AK} no longer varies with the voltage V_{AK}.

In the present invention, the current-detecting circuit 60 is configured to detect the current flowing through the switch QN1 and determine whether the corresponding voltage V_{AK} exceeds V_{DROP}. In the embodiment depicted in FIG. 8, the current-detecting circuit 60 includes a resistor R, a switch QN2 and a comparator CP0. The resistor R is used for providing a feedback voltage V_{FB} which is associated with the current passing the switch QN1. The switch QN2 is coupled in parallel with the resistor R. When the voltage V_{AK} starts to ramp up but is still too low for providing a sufficient turn-on current, the switch QN2 may be turned on for lowering the effective impedance of the resistor R, thereby shortening the turn-on time. When V_{AK} ramps up near V_{DROP}, the switch QN2 is turned off. The comparator CP0 is configured to output a corresponding control signal S1 to the control circuit 50 according to the relationship between the feedback voltage V_{FB} and a reference voltage V_{REF}. If V_{FB}>V_{REF}, the control circuit 50 maintains the gate-to-source voltage V_{GS} to a predetermined value which is larger than the threshold voltage V_{TH}, thereby limiting the current I_{AK} to I_{MAX}.

The voltage-detecting circuit 70 includes a logic circuit 72, a voltage edge-detecting circuit 74, and two hysteresis comparators CP1 and CP2. The hysteresis comparator CP1 is configured to determine the relationship between the voltages V_{AK}, V_{ON}_{_{—}}_{TH} and V_{ON}_{_{—}}_{TH}′, while the hysteresis comparator CP2 is configured to determine the relationship between the voltages V_{AK}, V_{OFF}_{_{—}}_{TH} and V_{OFF}_{_{—}}_{TH}′. Meanwhile, when the voltages V_{AK} is between V_{OFF}_{_{—}}_{TH} and V_{ON}_{_{—}}_{TH}, the voltage edge-detecting circuit 74 is configured to determine whether the rectified AC voltage V_{AC} is during the rising period or during the falling period. Based on the results of the voltage edge-detecting circuit 74 and the hysteresis comparators CP1 and CP2, the logic circuit 72 outputs a corresponding control signal S2 to the control circuit 50. During the rising period of the rectified AC voltage V_{AC} when the voltage V_{AK} is between V_{OFF}_{_{—}}_{TH} and V_{ON}_{_{—}}_{TH}, the control circuit 50 keeps the turn-on voltage V_{g} smaller than the threshold voltage V_{ON} according to the control signal S2, thereby turning off the switch QN1 and maintaining the current I_{AK} at zero. During the falling period of the rectified AC voltage V_{AC} when the voltage V_{AK} is between V_{ON}_{_{—}}_{TH} and V_{OFF}_{_{—}}_{TH}, the control circuit 50 keeps the turn-on voltage V_{g} larger than the threshold voltage V_{TH} according to the control signal S2, thereby operating the switch QN1 in the saturation region and maintaining the current I_{AK} at I_{MAX}.

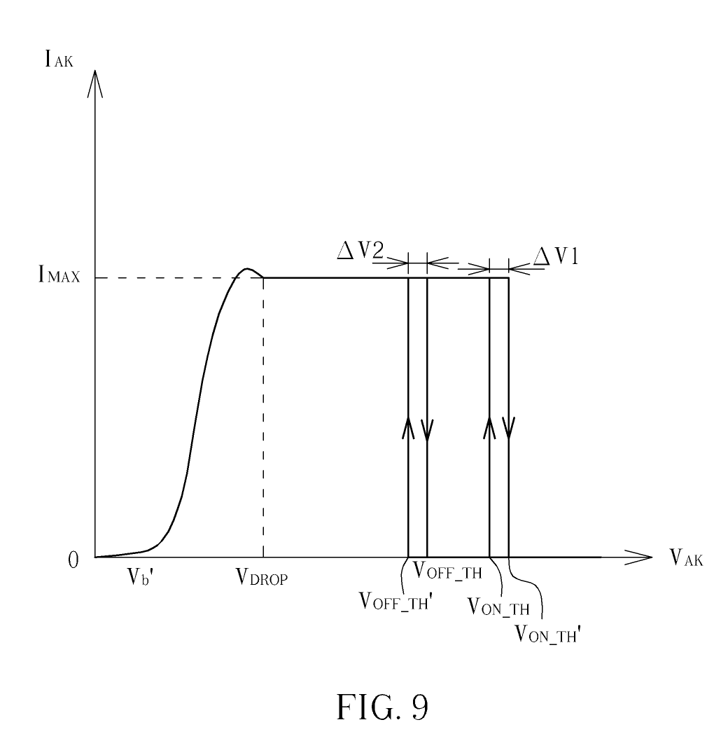

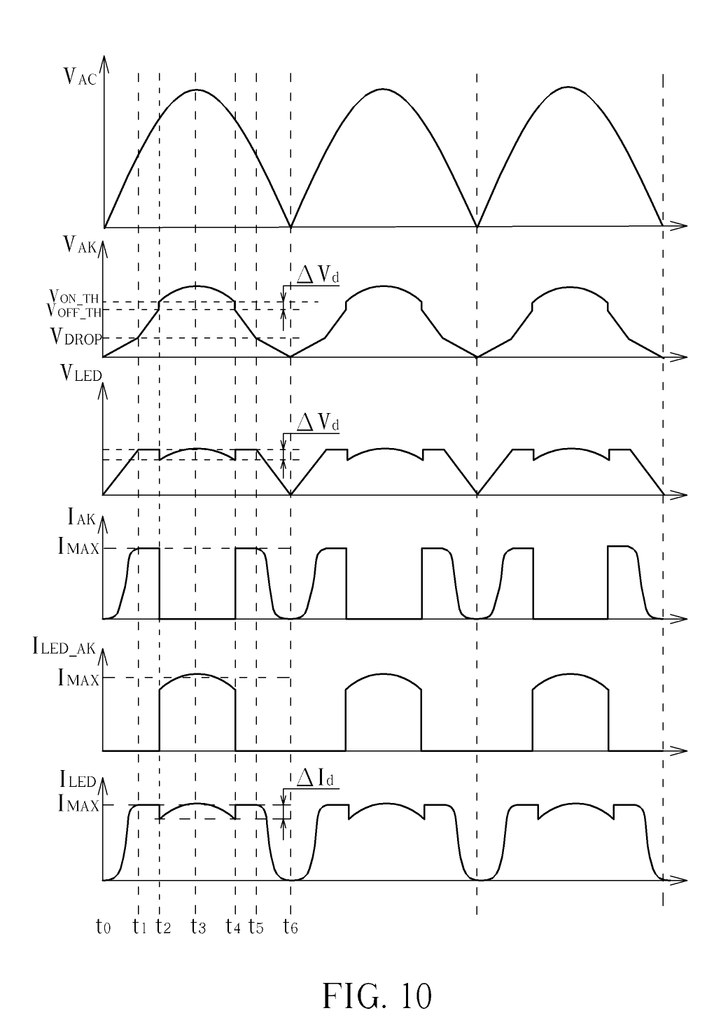

FIGS. 9 and 10 illustrate the operation of the LED lighting device 200 according to the second embodiment of the present invention, wherein FIG. 9 is a diagram illustrating the current-voltage chart of the two-terminal current controller 120, and FIG. 10 is a diagram illustrating the variations in the related current and voltage when operating the LED lighting device 200. In FIG. 9, the vertical axis represents the current I_{AK} passing through the two-terminal current controller 120, and the horizontal axis represents the voltage V_{AK} established across the two-terminal current controller 120.

During the rising period of the rectified voltage V_{AC}, the two-terminal current controller 120 operates in the first mode and functions as a voltage-controlled device when 0<V_{AK}<V_{DROP}. In other words, when the voltage V_{AK} exceeds the barrier voltage Vb′ of the two-terminal current controller 120, the current I_{AK} changes with the voltage V_{AK} in a specific manner. As previously stated, the switch QN2 is turned on when the voltage V_{AK} is still too low for providing a sufficient turn-on current. Since the effective impedance of the resistor R may be lowered by the turned-on switch QN2, the current I_{AK} may ramp up more rapidly. When the current I_{AK} reaches I_{MAX}, the switch QN2 is then turned off.

During the rising period of the rectified voltage V_{AC}, the two-terminal current controller 120 operates in the second mode and functions as a constant current source when V_{DROP}<V_{AK}<V_{OFF}_{_{—}}_{TH}. In other words, the current I_{AK} is maintained at a maximum current I_{MAX} instead of changing with the voltage V_{AK}.

During the rising period of the rectified voltage V_{AC}, the two-terminal current controller 120 operates in the third mode and is turned off when V_{AK}>V_{OFF}_{_{—}}_{TH}. In other words, the two-terminal current controller 120 functions as an open-circuited device since the current I_{AK} is suddenly reduced to zero.

During the falling period of the rectified voltage V_{AC}, the two-terminal current controller 120 is turned on and operates in the second mode for limiting the current I_{AK} to the maximum current I_{MAX} when V_{DROP}<V_{AK}<V_{ON}_{_{—}}_{TH}; the two-terminal current controller 120 operates in the first mode and functions as a voltage-controlled device when 0<V_{AK}<V_{DROP}. In other words, when the voltage V_{AK} exceeds the barrier voltage Vb′ of the two-terminal current controller 120, the current I_{AK} changes with the voltage V_{AK} in a specific manner.

In the present invention, the hysteresis comparators CP1 and CP2 are configured to provide hysteresis bands ΔV1 and ΔV2 in order to prevent small voltage fluctuations due to noise from causing undesirable rapid switches between operational. More specifically, the hysteresis comparator CP1 introduces two switching points, V_{ON}_{_{—}}_{TH} for falling voltages and V_{ON}_{_{—}}_{TH′} for rising voltages, which define the hysteresis band ΔV1. Similarly, the hysteresis comparator CP2 introduces two switching points, V_{OFF}_{_{—}}_{TH} for rising voltages and V_{OFF}_{_{—}}_{TH′} for falling voltages, which define the hysteresis band ΔV2.

During the rising period of the rectified voltage V_{AC} when V_{AK} exceeds V_{OFF}_{_{—}}_{TH}, the two-terminal current controller 120 switches to the third mode. If the voltage level of V_{AK} somehow fluctuates near V_{OFF}_{_{—}}_{TH}, the two-terminal current controller 120 may switch back to the second mode or stay in the third mode depending on whether the voltage fluctuation is within the hysteresis band ΔV2. For example, if V_{AK} reaches a value V2 between V_{OFF}_{_{—}}_{TH} and V_{ON}_{_{—}}_{TH}, drops to a value V1 smaller than V_{OFF}_{_{—}}_{TH′} and then resumes V2, the two-terminal current controller 120 is configured to sequentially operate in the third mode, the second mode and the third mode since the voltage fluctuation (V2-V1) is larger than the hysteresis band ΔV2. On the other hand, if V_{AK} reaches a value V2 between V_{OFF}_{_{—}}_{TH} and V_{ON}_{_{—}}_{TH}, drops to a voltage V1′ between V_{OFF}_{_{—}}_{TH′} and V_{OFF}_{_{—}}_{TH}, then resumes V2, the two-terminal current controller 120 is configured to stay in the third mode.

During the falling period of the rectified voltage V_{AC} when V_{AK} drops below V_{ON}_{_{—}}_{TH}, the two-terminal current controller 120 switches to the second mode. If the voltage level of V_{AK} somehow fluctuates near V_{ON}_{_{—}}_{TH}, the two-terminal current controller 120 may switch back to the third mode or stay in the second mode depending on whether the voltage fluctuation is within the hysteresis band ΔV1. For example, if V_{AK} drops to a value V2 between V_{OFF}_{_{—}}_{TH} and V_{ON}_{_{—}}_{TH}, raises to a value V3 larger than V_{ON}_{_{—}}_{TH′} and then resumes V2, the two-terminal current controller 120 is configured to sequentially operate in the second mode, the third mode, and the second mode. On the other hand, if V_{AK} drops to a value V2 between V_{OFF}_{_{—}}_{TH} and V_{ON}_{_{—}}_{TH}, raises to a value V3′ between V_{ON}_{_{—}}_{TH} and V_{ON}_{_{—}}_{TH′}, then resumes V2, the two-terminal current controller 120 is configured to stay in the second mode since the voltage fluctuation (V3′-V2) is smaller than the hysteresis band Δ V1.

FIG. 10 illustrates the waveforms of the voltage V_{AC}, V_{AK}, V_{LED} and the current I_{AK}, I_{LED}_{_{—}}_{AK} and I_{LED}. Since the rectified AC voltage V_{AC} varies periodically with time, a cycle between t₀-t₆ is used for illustration, wherein the period between t₀-t₃ is the rising period of the rectified AC voltage V_{AC} and the period between t₄-t₆ is the falling period of the rectified AC voltage V_{AC}. Between t₀-t₁, the voltage V_{AK} established across the two-terminal current controller 120 and the voltage V_{LED} established across the n serially-coupled light-emitting units D₁-Dₙ increase with the rectified AC voltage V_{AC}. Due to smaller barrier voltage, the two-terminal current controller 120 is first turned on, after which the current I_{AK} and the current I_{LED} increase with the voltage V_{AK} in a specific manner and the current I_{LED}_{_{—}}_{AK} is maintained at substantially zero.

Between t₁-t₂ when the voltage V_{AK} is larger than the voltage V_{DROP}, the two-terminal current controller 120 is configured to limit the current I_{AK} to the maximum current I_{MAX}, and the current I_{LED} remains substantially zero since the luminescent element 21 is still turned off. With V_{F} representing the forward-bias voltage of each light-emitting unit in the luminescent element 25, the value of the voltage V_{LED} may be represented by m*V_{F}. Therefore, the luminescent element 21 is not conducting between t₀-t₂, and the rectified AC voltage V_{AC} provided by the power supply circuit 110 is applied to the two-terminal current controller 120 and the n light-emitting units in the luminescent element 25, depicted as follows:

V_{AC}=V_{AK}+V_{LED} (1)

Between t₂-t₄ when the voltage V_{AK} is larger than the voltage V_{OFF}_{_{—}}_{TH}, the two-terminal current controller 120 is turned off and the current associated with the rectified AC voltage V_{AC} thus passes through the luminescent elements 21 and 25. The current I_{AK} is reduced to zero, and the current I_{LED}_{_{—}}_{AK} changes with the voltage V_{AK}. Therefore, when the two-terminal current controller 120 is conducting between t₂ and t₄, the voltage V_{AK} established across the two-terminal current controller 120 is supplied as the luminescent device 20 performs voltage dividing on the rectified AC voltage V_{AC}, depicted as follows:

$${V}_{AK} = \frac{m}{m + n} \times {V}_{A C} \qquad ( 2 )$$

Between t₄-t₅ when the voltage V_{AK} drops to a value between the voltage V_{DROP} and the voltage V_{ON}_{_{—}}_{TH}, the two-terminal current controller 120 is turned on, thereby limiting the current I_{AK} to the maximum current I_{MAX} and maintaining the current I_{LED}_{_{—}}_{AK} at substantially zero. Between t₅-t₆ when the voltage V_{AK} drops below the voltage V_{DROP}, the current I_{AK} decreases with the voltage V_{AK} in a specific manner. As depicted in FIGS. 7 and 9, the value of the current I_{LED} is the sum of the current I_{LED}_{_{—}}_{AK} and the current I_{AK}. The two-terminal current controller 120 according to the second embodiment of the present invention may increase the effective operational voltage range (such as the output of the rectified AC voltage V_{AC} during t₁-t₂ and t₄-t₅), thereby increasing the power factor of the LED luminescence device 200.

In the second embodiment of the present invention, the moment when the two-terminal current controller 120 is switched on or switched off, the voltage V_{AK} and the voltage V_{LED} both encounter a sudden voltage drop ΔV_{d}, which results in a current fluctuation ΔI_{d}. The voltage drop ΔV_{d} may be represented as follows:

ΔV_{d}=V_{ON}_{_{—}}_{TH}−V_{OFF}_{_{—}}_{TH} (3)

According to equation (1), prior to t₂ at the time when the voltage V_{AK} reaches the voltage V_{OFF}_{_{—}}_{TH}, the rectified AC voltage V_{AC} may be represented as follows:

V_{AC}=V_{OFF}_{_{—}}_{TH}+n*V_{F} (4)

According to equation (2), prior to t₄ at the time when the voltage V_{AK} reaches the voltage V_{ON}_{_{—}}_{TH}, the rectified AC voltage V_{AC} may be represented as follows:

$${V}_{AK} = {V}_{ON \_ TH} = \frac{m}{m + n} \times {V}_{A C} \qquad ( 5 )$$

Introducing equation (4) into equation (5) results in:

$${V}_{ON \_ TH} = \frac{m}{m + n} \times ( {V}_{OFF \_ TH} + n \times {V}_{F} ) \qquad ( 6 )$$

Introducing equation (6) into equation (3) results in:

$${V}_{d} = \frac{m \times n}{m + n} \times {V}_{F} - \frac{n}{m + n} \times {V}_{OFF , TH} \qquad ( 7 )$$

In actual applications, the value of the voltage V_{OFF}_{_{—}}_{TH} maybe determined according to the maximum power dissipation P_{D}_{_{—}}_{MAX} and the maximum output current I_{MAX} of the two-terminal current controller 120, depicted as follows:

P_{D}_{_{—}}_{MAX}=V_{OFF}_{_{—}}_{TH}*I_{MAX} (8)

According to equations (7) and (8), the voltage drop ΔV_{d} may be adjusted by changing m and n. For example, for the same amount (m+n) of the light-emitting units in the luminescent device 20, the voltage drop ΔV_{d} may be reduced by choosing a larger value of n, thereby providing a more stable driving current I_{LED}.

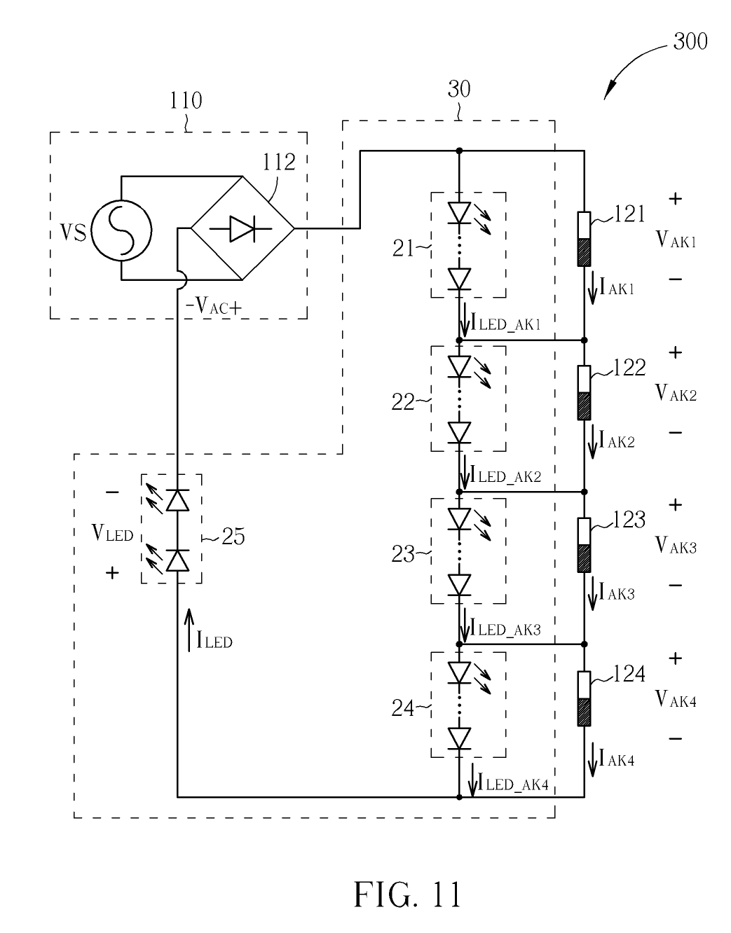

FIG. 11 is a diagram of an LED lighting device 300 according to a third embodiment of the present invention. The LED lighting device 300 includes a power supply circuit 110, a plurality of two-terminal current controllers, and a luminescent device 30. Having similar structures, the third embodiment differs from the second embodiment in that the LED lighting device 300 includes a plurality of two-terminal current controllers (FIG. 11 depicts 4 two-terminal current controllers 121-124) and luminescent device 30 includes a plurality of luminescent elements (FIG. 11 depicts 5 luminescent elements 21-25). The luminescent elements 21-24, respectively coupled in parallel with the corresponding two-terminal current controllers 121-124, each include a plurality of light-emitting units coupled in series, wherein I_{LED}_{_{—}}_{AK1}-I_{LED}_{_{—}}_{AK4} respectively represent the currents flowing through the luminescent elements 21-24 and V_{AK1}-V_{AK4} respectively represent the voltages established across the luminescent element elements 21-24. The luminescent element 25, coupled in series to the two-terminal current controllers 121-124, includes a plurality of light-emitting units coupled in series, wherein I_{LED} represents the current flowing through the luminescent element 25 and V_{LED} represents the voltage established across the luminescent element 25. Each light-emitting unit may include a single light-emitting diode or multiple light-emitting diodes, and FIG. 11 depicts the embodiment using a single light-emitting diode. In the embodiment shown in FIG. 11, the two-terminal current controllers 121-124 are configured to regulate the currents passing through the corresponding luminescent element elements 21-24 according to the voltages V_{AK1}-V_{AK4}, respectively, wherein I_{AK1}-I_{AK4} respectively represent the currents flowing through the two-terminal current controllers 121-124 and V_{AK1}-V_{AK4} respectively represent the voltages established across the two-terminal current controllers 121-124. In the third embodiment of the present invention, the barrier voltages of the two-terminal current controllers 121-124 are smaller than the overall barrier voltages of the corresponding luminescent elements 21-24.

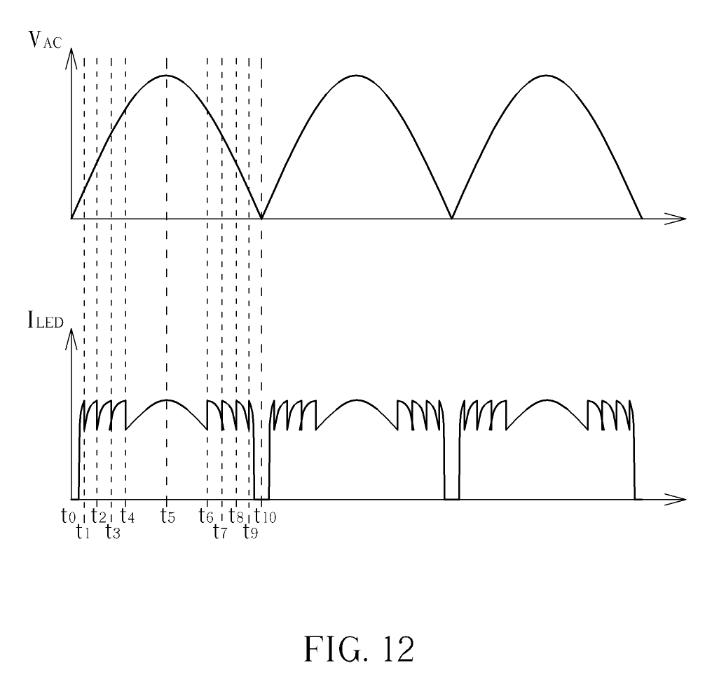

Reference may also be made to FIG. 9 for the current-voltage chart of each two-terminal current controller in the LED lighting device 300. The values of V_{DROP1}-V_{DROP4}, V_{OFF}_{_{—}}_{TH1}-V_{OFF}_{_{—}}_{TH4}, V_{ON}_{_{—}}_{TH1}-V_{ON}_{_{—}}_{TH4}, V_{OFF}_{_{—}}_{TH1′}-V_{OFF}_{_{—}}_{TH4′} and V_{ON}_{_{—}}_{TH1′}-V_{ON}_{_{—}}_{TH4′} may be determined according to the maximum power dissipation and the maximum output current of the two-terminal current controllers 121-124, as well as the characteristics and the amount of the light-emitting diodes in use. FIG. 12 is a diagram illustrating the operation of the LED lighting device 300 according to the third embodiment of the present invention. Since the rectified AC voltage V_{AC} varies periodically with time, a cycle between t₀-t₁₀ is used for illustration, wherein the period between t₀-t₅ is the rising period of the rectified AC voltage V_{AC} and the period between t₅-t₁₀ is the falling period of the rectified AC voltage V_{AC}.

The operation of the LED lighting device 300 during the rising period t₀-t₅ is hereby explained. Between t₀-t₁ when the voltages V_{AK1}-V_{AK4} increase with the rectified voltage V_{AC}, the two-terminal current controllers 121-124 are turned on earlier due to smaller barrier voltages, and the current flows from the power supply circuit 110 to the luminescent element 25 sequentially via the two-terminal current controllers 121-124 (i.e., I_{LED}=I_{AK1}=I_{AK2}=I_{AK3}=I_{AK4} and I_{LED}_{_{—}}_{AK1}=I_{LED}_{_{—}}_{AK2}=I_{LED}_{—}_{AK3}=I_{LED}_{_{—}}_{AK4}≈0). Between t₁-t₂ when the voltage V_{AK1} is larger than the voltage V_{OFF}_{_{—}}_{TH1}, the two-terminal current controller 121 is turned off first, and the current flows from the power supply circuit 110 to the luminescent element 25 sequentially via the luminescent element 21 and the two-terminal current controllers 122-124 (i.e., I_{LED}=I_{LED}_{_{—}}_{AK1}=I_{AK2}=I_{AK3}=I_{AK4} and I_{AK1}=I_{LED}_{_{—}}_{AK2}=I_{LED}_{_{—}}_{AK3}=I_{LED}_{_{—}}_{AK4}≈0). Between t₂-t₃ when the voltage V_{AK2} is larger than the voltage V_{OFF}_{₁₃} _{TH2}, the two-terminal current controller 122 is turned off next, and the current flows from the power supply circuit 110 to the luminescent element 25 sequentially via the luminescent element 21, the luminescent element 22 and the two-terminal current controllers 123-124 (i.e., I_{LED}=I_{LED}_{_{—}}_{AK1}=I_{LED}_{_{—}}_{AK2}=I_{AK3}=I_{AK4} and I_{AK1}=I_{AK2} 32 I_{LED}_{_{—}}_{AK3}=I_{LED}_{_{—}}_{AK4}≈0). Between t₃-t₄ when the voltage V_{AK3} is larger than the voltage V_{OFF}_{_{—}}_{TH3}, the two-terminal current controller 123 is turned off next, and the current flows from the power supply circuit 110 to the luminescent element 25 sequentially via the luminescent element 21, the luminescent element 22, the luminescent element 23 and the two-terminal current controller 124 (i.e., I_{LED}=I_{LED}_{_{—}}_{AK1}=I_{LED}_{_{—}}_{AK2}=I_{LED}_{_{—}}_{AK3}=I_{AK4} and I_{AK1}=I_{AK2}=I_{AK3}=I_{LED}_{_{—}}_{AK4}≈0). Between t₄-t₅ when the voltage V_{AK4} is larger than the voltage V_{OFF}_{_{—}}_{TH4}, the two-terminal current controller 124 is turned off next, and the current flows from the power supply circuit 110 to the luminescent element 25 sequentially via the luminescent elements 21-24 (i.e., I_{LED}=I_{LED}_{_{—}}_{AK1}=I_{LED}_{_{—}}_{AK2}=I_{LED}_{_{—}}_{AK3}=I_{LED}_{_{—}}_{AK4} and I_{AK1}=I_{AK2}=I_{AK3}=I_{AK4}≈0). During the falling period t₅-t₁₀, when the voltages V_{AK4}-V_{AK1} sequentially drop below V_{ON}_{_{—}}_{TH4}-V_{ON}_{_{—}}_{TH1}, respectively, the two-terminal current controllers 124-121 are sequentially turned on at t₆-t₉, respectively. The operation of the LED lighting device 300 during the falling period t₅-t₁₀ is similar to that during the corresponding rising period t₀-t₅ as previously illustrated.

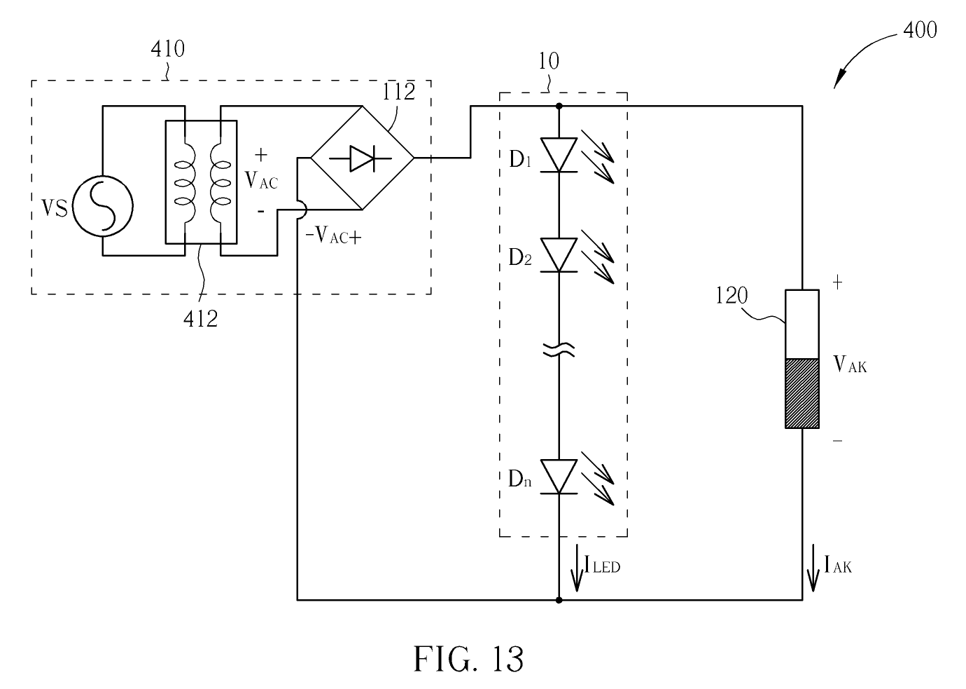

FIG. 13 is a diagram illustrating an LED lighting device 400 according to a fourth embodiment of the present invention. The LED lighting device 400 includes a power supply circuit 410, a two-terminal current controller 120, and a luminescent device 10. Having similar structures, the first and fourth embodiments of the present invention differ in the power supply circuits. In the first embodiment of the present invention, the power supply circuit 110 is configured to rectify the AC voltage VS (such as 110-220V main) using the bridge rectifier 112, thereby providing the rectified AC voltage V_{AC} whose value varies periodically with time. In the fourth embodiment of the present invention, the power supply circuit 410 is configured to receive any AC voltage VS, perform voltage conversion using an AC-AC converter 412, and rectify the converted AC voltage VS using the bridge rectifier 112, thereby providing the rectified AC voltage V_{AC} whose value varies periodically with time. References may be also be made to FIGS. 5 and 6 for illustrating the operation of the LED lighting device 400. Similarly, the second and third embodiments of the present invention may also use the power supply circuit 410 for providing the rectified AC voltage V_{AC}.

In the LED lighting devices 100, 200, 300 and 400 of the present invention, the number of the two-terminal current controllers 120-124, the number and configuration of the luminescent elements 21-25, and the type of the power supply circuits 110 and 410 may be determined according to different applications. FIGS. 4, 7, 11 and 13 are merely for illustrative purpose and do not limit the scope of the present invention. Also, the two-terminal current controller 120 may adopt devices which are able to provide characteristics as shown in FIGS. 5, 6, 9, 10 and 12.

The LED lighting device of the present invention regulates the current flowing through the serially-coupled light-emitting diodes and controls the number of the turned-on light-emitting diodes using a two-terminal current controller. Some of the light-emitting diodes may be conducted before the rectified AC voltage reaches the overall barrier voltage of all light-emitting diodes for improving the power factor. The introduction of hysteresis comparators in the two-terminal current controller 120 may improve noise resistance of the LED lighting device. The current-detecting circuit 60 with adjustable effective impedance may shorten the turn-on time of the two-terminal current controller 120 to improve the power factor. Therefore, the present invention may provide lighting devices having large effective operational voltage range, high brightness, high noise resistance and short turn-on time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A two-terminal current controller for controlling a first current flowing through a load which is coupled in parallel with the two-terminal current controller, wherein:
during a rising period of a rectified AC voltage when a voltage established across the load does not exceed a first voltage, the two-terminal current controller operates in a first mode;
during the rising period when the voltage established across the load exceeds the first voltage but does not exceed a second voltage, the two-terminal current controller operates in a second mode; and
during the rising period when the voltage established across the load exceeds the second voltage, the two-terminal current controller operates in a third mode;
during the rising period when the voltage established across the load drops to a third voltage smaller than the second voltage after exceeding the second voltage, the two-terminal current controller is configured to:
operate in the second mode when a difference between the second and third voltages exceeds a first hysteresis band; and
operate in the third mode when a difference between the second and third voltages does not exceed the first hysteresis band;
the two-terminal current controller includes:
a current limiting unit configured to:
conduct a second current associated with the rectified AC voltage, regulate the second current according to the voltage established across the load and maintain the first current at zero when the two-terminal current controller operates in the first mode;
conduct the second current, maintain the second current at a predetermined value larger than zero and maintain the first current at zero when the two-terminal current controller operates in the second mode; and
switch off when the two-terminal current controller operates in the third mode.

2. The two-terminal current controller of claim 1, wherein when the voltage established across the two-terminal current controller becomes smaller than a fourth voltage but is larger than the first voltage during a falling period of the rectified AC voltage, the two-terminal current controller operates in the second mode for maintaining the first current at substantially zero and setting the second current to the predetermined value, and the fourth voltage is larger than the second voltage.

3. The two-terminal current controller of claim 2, wherein when the voltage established across the two-terminal current controller becomes larger than a fifth voltage which is larger than the fourth voltage after becoming smaller than the fourth voltage during the falling period of the rectified AC voltage, the two-terminal current controller is configure to:
operate in the third mode when a difference between the fourth and fifth voltages exceeds a second hysteresis band; and
operate in the second mode when a difference between the fourth and fifth voltages does not exceed the second hysteresis band.

4. The two-terminal current controller of claim 3 further comprising:
a first switch configured to conduct the second current according to a turn-on voltage;
a control circuit configured to provide the turn-on voltage according to a first control signal and a second control signal;
a current-detecting circuit configured to determine whether the voltage established across the two-terminal current controller is larger than the first voltage according to the second current, thereby providing the first control signal accordingly; and
a voltage-detecting circuit configured to determine relationships between the voltage established across the two-terminal current controller, the second voltage and the fourth voltage, thereby providing the second control signal accordingly.

5. The two-terminal current controller of claim 4, wherein:
when the current-detecting circuit determines that the voltage established across the two-terminal current controller does not exceed the first voltage, the switch regulates the second current according to the turn-on voltage; and
when the current-detecting circuit determines that the voltage established across the two-terminal current controller is larger than the first voltage, the switch limits the second current to the predetermined value according to the turn-on voltage.

6. The two-terminal current controller of claim 4, wherein:
when the voltage-detecting circuit determines that the voltage established across the two-terminal current controller is larger than the first voltage and does not exceed the second voltage during the rising period, the switch limits the second current to the predetermined value according to the turn-on voltage and maintains the first current at substantially zero; and
when the voltage-detecting circuit determines that the voltage established across the two-terminal current controller is larger than the first voltage and does not exceed the fourth voltage during the falling period, the switch limits the second current to the predetermined value according to the turn-on voltage and maintains the first current at substantially zero.

7. The two-terminal current controller of claim 4 wherein the current-detecting circuit comprises:
a resistor coupled to the first switch for providing a feedback voltage according to the second current;
a second switch coupled in parallel to the resistor for adjusting an effective impedance of the resistor; and
a comparator for providing the first control signal according to a relationship between the feedback voltage and a reference voltage.

8. The two-terminal current controller of claim 4 wherein the voltage-detecting circuit comprises:
a voltage edge-detecting circuit configured to determine whether the voltage established across the two-terminal current controller is during the rising period or the falling period of the rectified AC voltage; and
a hysteresis comparator configured to determine a relationship between the voltage established across the two-terminal current controller, the second voltage and the third voltage.

9. The two-terminal current controller of claim 4 wherein the voltage-detecting circuit comprises:
a voltage edge-detecting circuit configured to determine whether the voltage established across the two-terminal current controller is during the rising period or the falling period of the rectified AC voltage;
a first hysteresis comparator configured to determine a relationship between the voltage established across the two-terminal current controller, the second voltage and the third voltage; and
a second hysteresis comparator configured to determine a relationship between the voltage established across the two-terminal current controller, the fourth voltage and the fifth voltage.

10. The two-terminal current controller of claim 1, wherein the two-terminal current controller functions as a voltage-controlled device when operating in the first mode in which the voltage established across the two-terminal current controller does not exceed the first voltage, functions as a current source when operating in the second mode in which the voltage established across the two-terminal current controller is larger than the first voltage and does not exceed the second voltage, and functions as an open-circuited device when operating in the third mode in which the voltage established across the two-terminal current controller is larger than the second voltage.
